(19) United States
(12) Patent Application Publication
(10) Pub. No.: US 2023/0014836 A1
(43) Pub. Date: Jan. 19, 2023

(54) METHOD FOR CHORUS MIXING, APPARATUS, ELECTRONIC DEVICE AND STORAGE MEDIUM

(71) Applicant: BEIJING DAJIA INTERNET INFORMATION TECHNOLOGY CO., LTD., Beijing (CN)

(72) Inventors: Nan LI, Beijing (CN); Chen ZHANG, Beijing (CN)

(21) Appl. No.: 17/833,949

(22) Filed: Jun. 7, 2022

(30) Foreign Application Priority Data
Jul. 16, 2021 (CN) 202110805138.9

(51) Int. Cl. G10H 1/00; G10H 1/38

(52) U.S. Cl. CPC G10H 1/0091; G10H 1/383; G10H 1/0008; G10H 2210/281; G10H 2240/325

(57) ABSTRACT

The present disclosure provides a method for chorus mixing, an apparatus, an electronic device and storage media. The method includes converting a main vocal audio signal and a chorus audio signal into signals in frequency domain, respectively, wherein the chorus audio signal comprises main vocal audio played by a speaker; determining a delay between the main vocal audio signal and the chorus audio signal based on a frequency-domain signal of the main vocal audio signal and a frequency-domain signal of the main vocal audio played by the speaker included in a frequency-domain signal of the chorus audio signal; aligning the chorus audio signal with the main vocal audio signal based on the determined delay; performing an echo cancellation on the aligned chorus audio signal; and mixing audio of the main vocal audio signal and the echo-canceled chorus audio signal.

### CROSS-REFERENCE TO RELATED APPLICATIONS

This application claims the priority of the Chinese Patent Application No. 202110805138.9, filed with China National Intellectual Property Administration on Jul. 16, 2021, the content of which is hereby incorporated by reference in its entirety.

### TECHNICAL FIELD

The present disclosure relates to the technical field of audio and video, and in particular, to methods for chorus mixing audio in, apparatuses for chorus mixing, electronic devices and storage media.

### BACKGROUND

With the improvement of the Internet and smart device technology, the use of Karaoke software on a mobile phone has become very popular, and using the Karaoke software to sing in chorus is a commonly used method of making karaoke works.

### SUMMARY

According to a first aspect of the present disclosure, a method for chorus mixing is provided. The method for chorus mixing includes: converting a main vocal audio signal and a chorus audio signal into signals in frequency domain, respectively, wherein the chorus audio signal includes main vocal audio played by a speaker; determining a delay between the main vocal audio signal and the chorus audio signal based on a frequency-domain signal of the main vocal audio signal and a frequency-domain signal of the main vocal audio played by the speaker included in a frequency-domain signal of the chorus audio signal; aligning the chorus audio signal with the main vocal audio signal based on the determined delay; performing an echo cancellation on the aligned chorus audio signal; and mixing audio of the main vocal audio signal and the echo-canceled chorus audio signal.

According to a second aspect of the present disclosure, a method for chorus mixing is provided. The method for chorus mixing includes: obtaining a clean main vocal audio signal from a main vocal audio signal with accompaniment; detecting frequency information of the clean main vocal audio signal and frequency information of a chorus audio signal; determining a delay between the main vocal audio signal and the chorus audio signal based on time series of the frequency information of the chorus audio signal and time series of frequency information of the clean main vocal audio signal; aligning the chorus audio signal with the main vocal audio signal based on the determined delay; and mixing audio of the main vocal audio signal and the aligned chorus audio signal.

According to a third aspect of the present disclosure, an electronic device is provided. The electronic device includes: at least one processor; at least one memory storing instructions executable by the processor, wherein the processor is configured to determine an output mode of a main vocal audio signal; in response to determining that the output mode of the main vocal audio signal is a speaker mode, perform actions comprising: converting a main vocal audio signal and a chorus audio signal into signals in frequency domain, respectively, wherein the chorus audio signal comprises main vocal audio played by a speaker; determining a delay between the main vocal audio signal and the chorus audio signal based on a frequency-domain signal of the main vocal audio signal and a frequency-domain signal of the main vocal audio played by the speaker included in a frequency-domain signal of the chorus audio signal; aligning the chorus audio signal with the main vocal audio signal based on the determined delay; performing an echo cancellation on the aligned chorus audio signal; and mixing audio of the main vocal audio signal and the echo-canceled chorus audio signal.

### BRIEF DESCRIPTION OF THE DRAWINGS

The accompanying drawings, which are incorporated in and constitute a part of this specification, illustrate implementations consistent with the present disclosure, and together with the description, serve to explain the principles of the present disclosure and do not unduly limit the present disclosure.

FIG. 1 is a diagram illustrating a system environment in which a method for chorus mixing and a corresponding apparatus according to some implementations of the present disclosure are applied.

FIG. 2 is a flowchart illustrating a method for chorus mixing according to some implementations of the present disclosure.

FIG. 3 is a flowchart illustrating a method for chorus mixing according to some implementations of the present disclosure.

FIG. 4 is a flowchart illustrating a method for chorus mixing according to some implementations of the present disclosure.

FIG. 5 is a block diagram illustrating an apparatus for chorus mixing according to some implementations of the present disclosure.

FIG. 6 is a block diagram illustrating an apparatus for chorus mixing according to some implementations of the present disclosure.

FIG. 7 is a block diagram illustrating an electronic device for chorus mixing according to the present disclosure.

### DETAILED DESCRIPTION

In order to enable those skilled in the art to better understand the technical solutions in one or more implementations of the present disclosure, in the following, the technical solution is described clearly and completely in conjunction with the drawings in one or more implementations of the present disclosure.

It should be noted that the terms “first”, “second” and the like in the specification and claims of the present disclosure and the above drawings are used to distinguish similar objects, and are not necessarily used to describe a specific sequence or order. It is to be understood that the data so used may be interchanged under appropriate circumstances such that the implementations of the disclosure described herein can be practiced in sequences other than those illustrated or described herein. The implementations described in the following examples are not intended to represent all implementations consistent with this disclosure. Rather, they are merely examples of apparatus and methods consistent with some aspects of the present disclosure as recited in the appended claims.

It should be noted here that “at least one of several items” in the present disclosure all means including three juxtaposed categories of “any one of the several items”, “a combination of any of the several items”, “the whole of the several items”. For example, “including at least one of A and B” includes the following three juxtaposed situations: (1) including A; (2) including B; (3) including A and B. Another example is “execute at least one of step 1 and step 2”, which means the following three juxtaposed situations: (1) execute step 1; (2) execute step 2; (3) execute step 1 and step 2.

In the process of recording chorus audio using the software in a smart device (such as a mobile phone, a computer, etc.), there is a certain delay in an excitation of a main vocal audio, i.e., the main vocal's audio, played by a system reaching a speaker when the smart device is in a speaker mode (i.e., without plugging in a headphone, the mobile phone diffuses sounds into air through its own speaker, and then the sounds are received by the human ear), and the delay will change and jitter. In this case, if a singer in chorus sings according to the main vocal audio actually played by the speaker, the main vocal audio and the chorus audio will be obviously misaligned during mixing audio, which will greatly affect the quality of the final chorus work. At the same time, during the process of playing the main vocal audio, a microphone of the smart device will collect the main vocal audio played by the speaker. Under the influence of the above-mentioned system delay, there will be multiple misplaced main vocal audio in the final work.

In the related art, after a song is recorded, a time slider that aligns the main vocal audio and the chorus audio is displayed to allow a recorder to make adjustments to the misplaced audio. However, this method requires manual operation by the user, which is inconvenient and difficult to be precise. In addition, this method cannot solve the problem that the audio of the main vocal exists in the recorded audio.

In addition, in the related art, based on the alignment of a musical score of the music digital interface and the audio pitch, the correlation between the pitch of the audio signal and the musical score can be compared, and time points of alignment can be found. However, this method needs to rely on accurate pitch detection and has low real-time performance. In addition, this method generally requires the audio signal to have a high signal-to-noise ratio, thus limiting the use of users without a headphone.

Before proceeding to the following description, some terms and principles used in this disclosure are first explained.

Acoustic Echo Cancellation (AEC): AEC uses an adaptive algorithm to adjust iterative update coefficients of the filter to estimate a desired signal, so that the desired signal approximates the echo signal passing through the actual echo path, and then subtracts this analog echo from a mixed signal collected by a microphone to achieve the function of echo cancellation.

Short Time Fourier Transform (STFT): STFT is a general tool for speech signal processing, which defines a very useful class of time and frequency distributions. The time and frequency distributions specify complex magnitudes of an arbitrary signal over time variation and frequency variation. The process of computing the Short-Time Fourier transform is to divide a longer-time signal into shorter segments of the same length, and compute the Fourier transform on each shorter segment, i.e., Fourier spectrum.

The technical solutions provided by the implementations of the present disclosure bring at least the following beneficial effects: the problem of multiple misplaced main vocals in chorus and the misplacement of the chorus audio and the main vocal can be solved automatically without manual intervention, the implementation is simple and reliable, and the quality of the choral work is ensured.

FIG. 1 shows a diagram of a system environment in which a method for chorus mixing and a corresponding apparatus according to some implementations of the present disclosure are applied.

As shown in FIG. 1, the method for chorus mixing provided by the present disclosure can be applied to the application environment shown in FIG. 1. The terminal 102 and the terminal 104 communicate with the server 106 through the network. When the terminal 102 is a local terminal, the terminal 104 is a remote terminal, and when the terminal 104 is a local terminal, the terminal 102 is a remote terminal. Specifically, the terminal 102 and the terminal 104 may be at least one of a mobile phone, a tablet computer, a desktop-type computer, a laptop-type computer, a handheld computer, a notebook computer, a netbook, a personal digital assistant (PDA), an augmented reality (AR)/a virtual reality (VR) device, and devices having an audio play function. The server 106 may be implemented by an independent server or a server cluster composed of multiple servers.

A method for estimating an echo delay according to some implementations of the present disclosure is described by taking an example of taking the terminal 102 as the local terminal (i.e., the main vocal terminal) and the terminal 104 as the remote terminal (i.e., the choral terminal) in the scenario of live streaming of LinkMic (that is, linking microphones). The main vocal audio signal may be generated by an audio module of the main vocal terminal 102. For example, the audio module includes a microphone, an audio processing chip, and/or a corresponding functional part of a processor). The choral terminal 104 can receive the main vocal audio signal from the main vocal terminal 102 through the server 106, and the user of the choral terminal 104 can chorus with the main vocal's audio while playing the main vocal audio signal, so that the chorus audio signal can be generated at the choral terminal 104, and then mix and record the main vocal audio signal and the received chorus audio signal at the choral terminal 104. Here, the choral terminal 104 can play the audio signal of the main vocal through the speaker in a speaker mode (i.e., without plugging in a headphone, the mobile phone diffuses sounds into air through its own speaker, and then the sounds are received by the human ear), or output the audio signal of the main vocal through the earphone connected to the choral terminal 104 in an earphone mode (i.e., plugging in a headphone to receive sounds), and simultaneously generate a chorus audio signal through an audio input device such as the microphone. Therefore, in the speaker mode, the chorus audio signal will contain the main vocal audio signal played by the speaker, while in headphone mode, the chorus audio signal will contain only the chorister's audio signal. It should be understood that the main vocal audio signal may also be a signal directly sent from the server 106 to the choral terminal 104, and the present disclosure does not limit the manner in which the main vocal audio signal is generated.

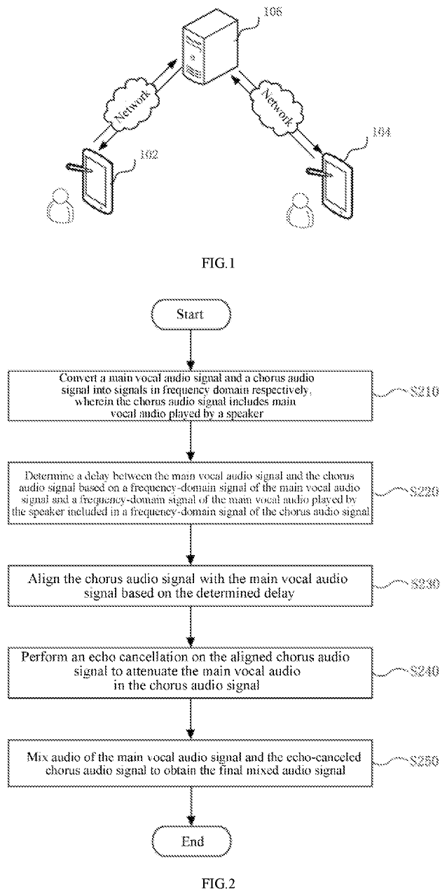

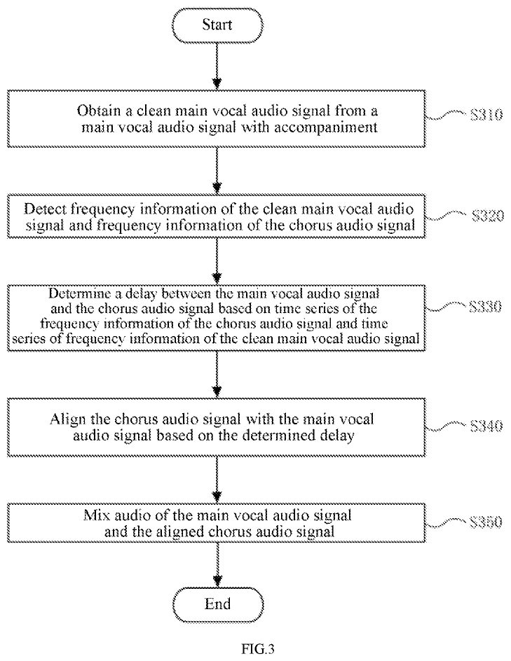

The method for performing the chorus mixing in the two modes will be described below with reference to FIG. 2 to FIG. 3.

FIG. 2 is a flowchart illustrating a method for chorus mixing according to some implementations of the present disclosure. The method for chorus mixing includes steps 210-250. In step 210, a main vocal audio signal and a chorus audio signal are respectively converted into signals in frequency domain, wherein the chorus audio signal includes main vocal audio played by the speaker. In step S220, a delay between the main vocal audio signal and the chorus audio signal is determined based on the frequency-domain signal of the main vocal audio signal and the frequency-domain signal of the main vocal audio signal played by the speaker included in the frequency-domain signal of the chorus audio signal. In step S230, the chorus audio signal is aligned with the main vocal audio signal, based on the determined delay. In step S240, the main vocal audio signal in chorus audio signal is attenuated by performing an echo cancellation on the aligned chorus audio signal. In step S250, a final mixed audio signal is obtained by mixing the main vocal audio signal and the echo-cancelled chorus audio signal.

First, in step 210, a main vocal audio signal and a chorus audio signal are respectively converted into signals in frequency domain, and the chorus audio signal includes main vocal audio played by a speaker.

Here, a frequency-domain signal of the main vocal audio signal and a frequency-domain signal of the chorus audio signal containing the main vocal audio played by the speaker are generated by respectively performing a short-time Fourier transform (STFT) on the main vocal audio signal and the chorus audio signal containing the main vocal audio played by the speaker:

MAIN(n)=STFT(main(t),

CHORUS(n)=STFT(chorus(t)),

wherein, main(t) and chorus(t) respectively represent a time-domain audio signal of the main vocal audio signal and a time-domain audio signal of the chorus audio signal containing the main vocal audio played by the speaker, MAIN(n) represents a frequency-domain signal of the main vocal audio signal, and CHORUS(n) represents a frequency-domain signal of the chorus audio signal. Wherein, n is a frame sequence number, 0<n≤N, and N is the total number of frames. It should be noted that since the processing of each frequency band of the audio in the present disclosure is the same, a symbol indicating information of the frequency band is not reflected in frequency-domain signals. In addition, the chorus(t) signal and CHORUS(n) signal can be expressed as:

chorus(t)=cleanChorus(t)+spkMain(t),

CHORUS(n)=CLEANCHORUS(n)+SPKMAIN(n),

wherein, cleanChorus(t) and spkMain(t) respectively represent a time-domain audio signal of a clean (pure) chorus audio signal and a time-domain audio signal of the main vocal audio signal played by the speaker, while CLEANCHORUS(n) and SPKMAIN(n) respectively represent a frequency-domain signal of the clean chorus audio signal and a frequency-domain signal of the main vocal audio signal played by the speaker.

Next, in step S220, a delay between the main vocal audio signal and the chorus audio signal containing the main vocal audio played by the speaker is determined based on the frequency-domain signal of the main vocal audio signal and the frequency-domain signal of the main vocal audio signal played by the speaker included in the frequency-domain signal of the chorus audio signal.

Here, step S220 may determine the number of relative offset frames (i.e., the relative offset frame number) between the frequency-domain signal of the main vocal audio signal played by the speaker included in the frequency-domain signal of the chorus audio signal and the frequency-domain signal of the main vocal audio signal, and determine the delay according to the number of the relative offset frames. That is, the MAIN(n) signal and the CHORUS(n) signal may be input to a delay estimation module to estimate the delay of the SPKMAIN(n) signal component in CHORUS(n) relative to the MAIN(n) signal. The delay estimation module according to the implementations of the present disclosure may perform delay estimation based on, for example, delay estimation about correlation, delay estimation given spectral energy similarity, etc., without limitation on this. After the delay estimation process, an delay result delay (n) estimated at current time n is obtained, and the result represents the relative offset frame number between the MAIN(n) signal and the CHORUS(n) signal.

Next, in step S230, the chorus audio signal is aligned with the main vocal audio signal, based on the determined delay.

According to implementations of the present disclosure, the alignment may be dynamically adjusted according to variation of the delay of between the chorus audio signal and the main vocal audio signal. For example, a difference between a first delay and a second delay may be determined, wherein the first delay is a delay between the main vocal audio signal and the chorus audio signal containing the main vocal audio played by the speaker at current moment, and the second delay is a delay between the main vocal audio signal and the chorus audio signal containing the main vocal audio played by the speaker at a previous moment. In response to the difference between the first delay and the second delay being within a predetermined range, a time of playing the chorus audio signal is adjusted based on the second delay, i.e., the delay between the main vocal audio signal and the chorus audio signal containing the main vocal audio played by the speaker at the previous moment. In response to the difference between the first delay and the second delay being out of the predetermined rang, the time of playing the chorus audio signal is adjusted based on the first delay, i.e., the delay between the main vocal audio signal and the chorus audio signal containing the main vocal audio played by the speaker at the current moment.

Specifically, a maximum tolerance delay frame number (which is denoted as tolerance) can be set for the frequency-domain signal CHORUS(n) of the chorus audio signal and the frequency-domain signal MAIN(n) of the main vocal audio signal. For example, the tolerance can be the number of frames corresponding to 30 milliseconds of audio. When delay(n−1)≤delay(n)+tolerance and delay(n−1)≥delay(n)-tolerance, then the number of delayed samples is obtained based on the number of delayed frames at the previous moment, i.e., delaySamples(n)=framelen*delay(n−1), wherein framelen is the number of samples corresponding to one frame of audio data. In response determining that delay(n−1)<delay(n)-tolerance or delay(n−1)>delay(n)+tolerance, the number of delay frames at the current moment can be used to obtain the number of delay samples corresponding to the delay, i.e., delaySamples(n)=framelen*delay(n). Then, the chorus audio signal may be time-adjusted based on the number of delay samples, i.e., chorusAligned(t-delay Samples(n))=chorus(t).

That is to say, when the variations of the delay between the main vocal audio signal and the chorus audio signal at certain moments are not large, the human ear cannot perceive the delay variations, and therefore the adjustment may not be performed. However, through the above-mentioned delay adjustment method, the alignment adjustment of the time series can be introduced infrequently when the delay variation is small, so that artifacts caused by the discontinuity introduced by the alignment adjustment can be reduced.

In addition, after the delay adjustment as described above, a signal overlap or breakage caused by the delay variation can also be smoothed, so that the adjusted signal has better coherence.

Next, in step S240, the main vocal audio signal in chorus audio signal is attenuated by performing an echo cancellation on the aligned chorus audio signal.

According to implementations of the present disclosure, a residual main vocal audio signal in the aligned chorus audio signal may be echo-cancelled by using an original main vocal audio signal as a reference signal.

Specifically, the chorus audio signal containing the main vocal audio played by the speaker after aligning the delay (which is denoted as chorusAligned(t)) and the main vocal audio signal main(t) can be input into an echo cancellation module. Here, chorusAligned(t) can be represented by the following equation:

chorusAligned(t)=cleanChorusAligned(t)+spkMainAligned(t),

wherein,

cleanChorusAligned(t-delaySamples(n))=cleanChorus(t),

spkMainAligned(t-delaySamples(n))=spkMain(t),

The spkMainAligned(t) signal left in chorusAligned(t), i.e., the residual spkMainAligned(t) signal, is eliminated with the main(t) signal as a reference signal. According to implementations of the present disclosure, for example, echo cancellation based on time-domain adaptive filtering of the normalized least mean squares, echo cancellation based on adaptive filtering of the block frequency-domain, echo cancellation based on self-decomposition, etc. may be used. The present disclosure does not limit this. Echo cancellation can greatly reduce the spkMainAligned(t) component, and the attenuation can generally up to 10-20 dB. The signal output from this module can be expressed as:

chorusAlignedAecOut(t)=cleanChorusAligned(t)+spkMainAlignedAttenuate(t),

wherein, spkMainAlignedAttenuate(t) is the attenuated main vocal audio signal played by the speaker.

Finally, in step S250, a final mixed audio signal is obtained by mixing the main vocal audio signal and the echo-cancelled chorus audio signal (i.e., chorus audio signal on which an echo cancellation has been performed).

Here, an amplitude control may be performed on the main vocal audio signal and the echo-cancelled chorus audio signal, thereby preventing clipping distortion from occurring.

Specifically, the final chorus audio signal music(t) is obtained by mixing the adjusted chorus audio signal chorusAlignedAecOut(t) output in step S240 and the original main vocal signal main(t):

music(t)=limitation(main(t)+chorusAlignedAecOut(t))

wherein, limitation(*) means performing the amplitude control on the signal.

Through the chorus mixing method described above, main vocal voice played and collected by the device itself can be attenuated, and the chorus voice and the main vocal voice can be automatically aligned to avoid the problem that multiple misplaced main vocal voice and multiple misplaces between the chorus voice and the main vocal voice occurs in the final work.

A method for chorus mixing according to some implementations of the present disclosure will be described below with reference to FIG. 3. This method is suitable for mixing audio in headphone mode. As mentioned earlier, in the headphone mode, clean chorus voice is collected. The clean chorus voice does not contain sound of the main vocal audio played by the speaker. In this case, the method for mixing audio in chorus includes steps S310-S350. In step S310, a clean main vocal audio signal is obtained from a main vocal audio signal with accompaniment. In step S320, frequency information of the clean main vocal audio signal and frequency information of the chorus audio signal are detected. In step S330, a delay between the main vocal audio signal and the chorus audio signal is determined based on the time series of the frequency information of the chorus audio signal and the time series of the frequency information of the clean main vocal audio signal. In step S340, the chorus audio signal is aligned with the main vocal audio signal based on the determined delay. In step S350, the main vocal audio signal and the aligned chorus audio signal are mixed.

First, in step S310, a clean main vocal audio signal is obtained from a main vocal audio signal with accompaniment. The formula is expressed as follows:

mainVocal(t)=Spleeter[main(t)],

wherein, Spleeter[*] represents a voice and accompaniment separation processing. Here, any related art voice and accompaniment separation method may be employed to extract the clean main vocal audio signal.

Next, in step S320, frequency information of the clean main vocal audio signal and frequency information of the chorus audio signal are detected. Here, the frequency information of the main vocal audio signal mainVocal(t) and the frequency information of the chorus audio signal cleanChorus(t) at different times can be obtained respectively through the frequency detection method of the related art, so as to form a time series pitchChorus(t) of the frequency information of the chorus audio signal and a time series pitchMainVocal(t) of the frequency information of the clean main vocal audio signal, expressed by the formula as follows:

pitchChorus(t)=Pitch[cleanChorus(t)],

pitchMainVocal(t)=Pitch[mainVocal(t)],

wherein, Pitch[*] represents a frequency detection processing.

Then, in step S330, a delay between the main vocal audio signal and the chorus audio signal is determined based on the time series of the frequency information of the chorus audio signal and the time series of the frequency information of the clean main vocal audio signal.

According to an exemplary implementation of the present disclosure, the delay between main vocal audio signal and the clean vocal audio signal may be determined according to correlation or a minimum difference value between the time series based on the frequency information of the chorus audio signal and the time series based on the frequency information of the clean main vocal audio signal.

Next, in step S340, the chorus audio signal is aligned with the main vocal audio signal based on the determined delay.

According to implementations of the present disclosure, alignment may be performed in a manner similar to step S230. That is, the step of aligning the chorus audio signal with the main vocal audio signal based on the determined delay may include: determining a difference between a third delay and a fourth delay, wherein the third delay is a delay between the clean main vocal audio signal and the chorus audio signal at current moment, and the fourth delay is a delay between the clean main vocal audio signal and the chorus audio signal at a previous moment; in response to the difference between the third delay and the fourth delay being within a predetermined range, adjusting a time of playing the chorus audio signal based on the fourth delay; and in response to the difference between the third delay and the fourth delay being out of the predetermined rang, adjusting the time of playing the chorus audio signal based on the fourth delay. Likewise, after alignment, a smoothing process may be performed one or more overlaps and breaks of the adjusted chorus audio signal.

Finally, in step S350, the main vocal audio signal and the aligned chorus audio signal are mixed. Here, an amplitude control may be performed on the main vocal audio signal and the aligned chorus audio signal, so as to prevent clipping distortion.

Through the above solution, the automatic alignment of the chorus voice and the main vocal voice can be realized, and the phenomenon of misplaces of the main vocal voice and the chorus voice can be prevented.

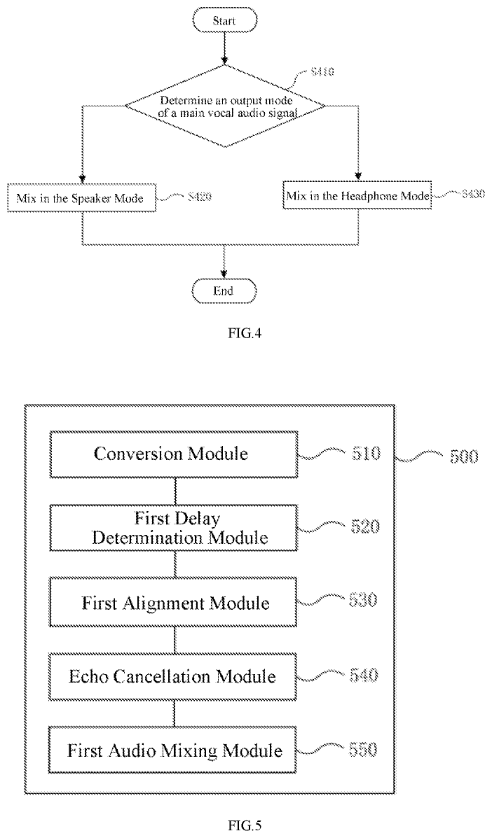

FIG. 4 is a flowchart illustrating a method for chorus mixing according to some implementations of the present disclosure.

First, in step S410, an output mode of a main vocal audio signal is determined. The output mode may be determined according to an audio output state of a device that performs chorus mixing. For example, when it is determined that no earphone is connected to the device, the output mode can be determined as a speaker mode, and when it is determined that the earphone is connected to the device, the output mode can be determined as an earphone mode.

Next, in step S420, in response to determining that the output mode of the main vocal audio signal is the speaker mode, the chorus audio signal and the main vocal audio signal are mixed by using the method for chorus mixing directed at the speaker mode described with reference to FIG. 2. In response to determining that the output mode of the main vocal audio signal is the headphone mode, the chorus audio signal and the main vocal audio signal may be mixed by using the method for chorus mixing directed at the headphone mode described with reference to FIG. 3.

The method for chorus mixing in the speaker mode and the method for chorus mixing in the headphone mode have been described above with reference to FIG. 2 and FIG. 3, and the description will not be repeated here.

FIG. 5 is a block diagram illustrating an apparatus for chorus mixing 500 according to implementations of the present disclosure. The apparatus for chorus mixing 500 may be used to mix the chorus audio signal and the main vocal audio signal in the speaker mode. It should be understood that each module in FIG. 5 may be further divided into more modules or integrated into fewer modules as required.

As shown in FIG. 5, the apparatus 500 for chorus mixing may include a conversion module 510, a first delay determination module 520, a first alignment module 530, an echo cancellation module 540 and a first audio mixing module 550.

The conversion module 510 is configured to convert a main vocal audio signal and a chorus audio signal into signals in frequency domain, respectively, wherein the chorus audio signal includes main vocal audio played by the speaker. As described above with reference to FIG. 2, the conversion module 510 may convert the main vocal audio signal and the chorus audio signal into respective corresponding frequency-domain signals by using the STFT.

The first delay determination module 520 is configured to determine a delay between the main vocal audio signal and the chorus audio signal based on a frequency-domain signal of the main vocal audio signal and a frequency-domain signal of the main vocal audio played by the speaker included in a frequency-domain signal of the chorus audio signal.

The first alignment module 530 is configured to align the chorus audio signal with the main vocal audio signal based on the determined delay.

The echo cancellation module 540 is configured to perform an echo cancellation on the aligned chorus audio signal to attenuate the main vocal audio signal in chorus audio signal.

The first audio mixing module 550 is configured to mix audio of the main vocal audio signal and the echo-canceled chorus audio signal.

According to some implementations of the present disclosure, the first delay determination module 520 is configured to determine a number of relative offset frames between the frequency-domain signal of the main vocal audio played by the speaker included in the frequency-domain signal of the chorus audio signal and the frequency-domain signal of the main vocal audio signal; and determine the delay based on the number of relative offset frames.

According to implementations of the present disclosure, the first alignment module 530 is configured to determine a difference between a first delay and a second delay, wherein the first delay is a delay between the main vocal audio signal and the chorus audio signal containing the main vocal audio played by the speaker at a current moment, and the second delay is a delay between the main vocal audio signal and the chorus audio signal containing the main vocal audio played by the speaker at a previous moment; in response to the difference between the first delay and the second delay being within a predetermined range, adjust a time of playing the chorus audio signal based on the second delay; and in response to the difference between the first delay and the second delay being out of the predetermined range, adjust the time of playing the chorus audio signal based on the first delay.

According to some implementations of the present disclosure, the first alignment module 530 is further configured to perform a smoothing process on an overlap and a break of the adjusted chorus audio signal.

According to some implementations of the present disclosure, the echo cancellation module 540 is configured to perform the echo cancellation on the aligned chorus audio signal with the main vocal audio signal as a reference signal, so as to attenuate a residual main vocal audio signal in the chorus audio signal.

According to some implementations of the present disclosure, the first audio mixing module 550 is configured to perform an amplitude control on the main vocal audio signal and the chorus audio signal on which echo cancellation has been performed.

It should be understood that the operations performed by the respective modules of the apparatus 500 for chorus mixing correspond to the respective operations of the method chorus mixing described above with reference to FIG. 2, and the description will not be repeated here.

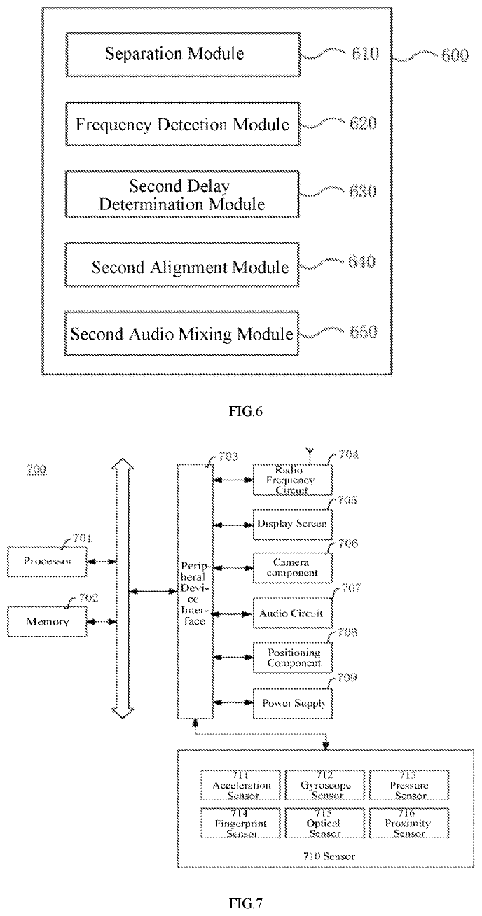

FIG. 6 is a block diagram of an apparatus for chorus mixing according to some implementations of the present disclosure.

The apparatus 600 for chorus mixing may be used to mix the chorus audio signal and the main vocal audio signal in headphone mode. It should be understood that each module in FIG. 6 may be further divided into more modules or integrated into fewer modules as required.

As shown in FIG. 6, the apparatus 600 for chorus mixing may include a separation module 610, a frequency detection module 620, a second delay determination module 630, a second alignment module 640 and a second audio mixing module 650.

The separation module 610 is configured to obtain a clean main vocal audio signal from a main vocal audio signal with accompaniment.

The frequency detection module 620 is configured to detect frequency information of the clean main vocal audio signal and frequency information of a chorus audio signal.

The second delay determination module 630 is configured to determine a delay between the main vocal audio signal and the chorus audio signal based on time series of the frequency information of the chorus audio signal and time series of frequency information of the clean main vocal audio signal.

The second alignment module 640 is configured to align the chorus audio signal with the main vocal audio signal based on the determined delay.

The audio mixing module 650 is configured to mix audio of the main vocal audio signal and the aligned chorus audio signal.

According to some implementations of the present disclosure, the second delay determination module 630 is configured to determine the delay between the chorus audio signal and the clean main vocal audio signal based on correlation or a minimum difference value between the time series of the frequency information of the chorus audio signal and the time series of the frequency information of the clean main vocal audio signal.

According to some implementations of the present disclosure, the second alignment module 640 is configured to determine a difference between a third delay and the fourth delay, wherein the third delay is a delay between the clean main vocal audio signal and the chorus audio signal at current moment, and the fourth delay is a delay between the clean main vocal audio signal and the chorus audio signal at a previous moment; in response to the difference between the third delay and the fourth delay being within a predetermined range, adjust a time of playing the chorus audio signal based on the fourth delay; and in response to the difference between the third delay and the fourth delay being out of the predetermined rang, adjust the time of the chorus audio signal based on the third delay.

According to some implementations of the present disclosure, the second alignment module 640 is further configured to perform a smoothing processing on an overlap and a break of the adjusted chorus audio signal.

According to some implementations of the present disclosure, the second audio mixing module 650 is configured to perform an amplitude control on the main vocal audio signal and the aligned chorus audio signal.

It should be understood that the operations performed by the respective modules of the apparatus 600 for chorus mixing correspond to the respective operations of the method for chorus mixing described above with reference to FIG. 3, and the description will not be repeated here.

It should be understood that the apparatus 500 for chorus mixing and the apparatus 600 for chorus mixing according to some implementations of the present disclosure may be implemented in one electronic device, so that the electronic device may select to use one of apparatus 500 for chorus mixing and the apparatus 600 for chorus mixing according to the output mode of the vocal audio signal, so that it can adapt to various chorus mixing scenes and ensure the quality of chorus mixing.

FIG. 7 is a structural block diagram illustrating an electronic device for chorus mixing according to some implementations of the present disclosure. The electronic device 700 can be, for example, a smart phone, a tablet computer, an MP3 player (Moving Picture Experts Group Audio Layer III), MP4 (Moving Picture Experts Group Audio Layer IV) Player, a laptop or a desktop. Electronic device 700 may also be called user equipment, portable terminal, laptop terminal, desktop terminal, and the like.

Generally, the electronic device 700 includes a processor 701 and a memory 702.

The processor 701 may include one or more processing cores, such as a 4-core processor, an 8-core processor, and the like. The processor 701 may be implemented by at least one hardware form of Digital Signal Processing (DSP), Field Programmable Gate Array (FPGA), and Programmable Logic Array (PLA). The processor 701 may also include a main processor and a coprocessor. The main processor is a processor used to process data in a wake-up state, also called a Central Processing Unit (CPU). The coprocessor is a low-power processor for processing data in a standby state. In some implementations, the processor 701 may be integrated with a Graphics Processing Unit (GPU), and the GPU is used for rendering and drawing the content that needs to be displayed on the display screen. In some implementations, the processor 701 may further include an Artificial Intelligence (AI) processor, wherein the AI processor is used to process computing operations related to machine learning.

Memory 702 may include one or more computer-readable storage media, which may be non-transitory. Memory 702 may also include high-speed random access memory, as well as non-volatile memory, such as one or more disk storage devices, flash storage devices. In some implementations, a non-transitory computer-readable storage medium in memory 702 is used to store at least one instruction for execution by processor 701 to implement methods according to the present disclosure as shown in FIGS. 2-4.

In some implementations, the electronic device 700 may optionally further include: a peripheral device interface 703 and at least one peripheral device. The processor 701, the memory 702 and the peripheral device interface 703 may be connected by a bus or a signal line. Each peripheral device can be connected to the peripheral device interface 703 through a bus, a signal line or a circuit board. Specifically, the peripheral devices include: a radio frequency circuit 704, a touch display screen 705, a camera 706, an audio circuit 707, a positioning component 708 and a power supply 709.

The peripheral device interface 703 may be used to connect at least one peripheral device related to Input/Output (I/O) to the processor 701 and the memory 702. In some implementations, processor 701, memory 702, and peripherals interface 703 are integrated on the same chip or circuit board. In some other implementations, any one or two of processor 701, memory 702, and peripherals interface 703 can be implemented on a separate chip or circuit board, which is not limited in this implementation.

The radio frequency circuit 704 is used for receiving and transmitting Radio Frequency (RF) signals, also called electromagnetic signals. The radio frequency circuit 704 communicates with the communication network and other communication devices via electromagnetic signals. The radio frequency circuit 704 may convert electrical signals into electromagnetic signals for transmission, or convert received electromagnetic signals into electrical signals. Alternatively, the radio frequency circuit 704 includes an antenna system, an RF transceiver, one or more amplifiers, a tuner, an oscillator, a digital signal processor, a codec chipset, a subscriber identity module card, and the like. The radio frequency circuit 704 may communicate with other terminals through at least one wireless communication protocol. The wireless communication protocol includes but is not limited to: metropolitan area network, mobile communication networks of various generations (2G, 3G, 4G and 5G), wireless local area network and/or Wireless Fidelity (WiFi) network. In some implementations, the radio frequency circuit 704 may further include a circuit related to NFC (Near Field Communication or short-range wireless communication), which is not limited in the present disclosure.

The display screen 705 is used to display a User Interface (UI). The UI can include graphics, text, icons, video, and any combination thereof When the display screen 705 is a touch display screen, the display screen 705 also has the ability to acquire touch signals on or above the surface of the display screen 705. The touch signal may be input to the processor 701 as a control signal for processing. At this time, the display screen 705 may also be used to provide virtual buttons and/or virtual keyboards, also referred to as soft buttons and/or soft keyboards. In some implementations, there may be one display screen 705, which is arranged on the front panel of the electronic device 700; in other implementations, there may be at least two display screens 705, which are respectively arranged on different surfaces of the terminal 700 or in a folded design. In still other implementations, the display screen 705 may be a flexible display screen, which is arranged on a curved surface or a folding surface of the terminal 700. Even, the display screen 705 can also be set as a non-rectangular irregular figure, that is, a special-shaped screen. The display screen 705 can be made of materials, such as Liquid Crystal Display (LCD), Organic Light-Emitting Diode (OLED).

The camera assembly 706 is used to capture images or video. Optionally, the camera assembly 706 includes a front camera and a rear camera. Usually, the front camera is arranged on the front panel of the terminal, and the rear camera is arranged on the back of the terminal. In some implementations, there are at least two rear cameras, which are any one of a main camera, a depth-of-field camera, a wide-angle camera, and a telephoto camera, so as to realize the fusion of the main camera and the depth-of-field camera to realize the background blur function, and realize the fusion of the main camera and the wide-angle camera to achieve panoramic shooting and Virtual Reality (VR) shooting functions or other fusion shooting functions. In some implementations, camera assembly 706 may also include a flash. The flash can be a single color temperature flash or a dual color temperature flash. The dual color temperature flash refers to the combination of warm light flash and cold light flash, which can be used for light compensation under different color temperatures.

Audio circuit 707 may include a microphone and speakers. The microphone is used to collect the sound waves of the user and the environment, convert the sound waves into electrical signals, and input them to the processor 701 for processing, or input them to the radio frequency circuit 704 to realize voice communication. For the purpose of stereo collection or noise reduction, there may be multiple microphones, which are respectively disposed in different parts of the terminal 700. The microphone may also be an array microphone or an omnidirectional collection microphone. The speaker is used to convert the electrical signal from the processor 701 or the radio frequency circuit 704 into sound waves. The speaker can be a traditional thin-film speaker or a piezoelectric ceramic speaker. When the speaker is a piezoelectric ceramic speaker, it can not only convert electrical signals into sound waves audible to humans, but also convert electrical signals into sound waves inaudible to humans for distance measurement and other purposes. In some implementations, the audio circuit 707 may also include a headphone jack.

The positioning component 708 is used to locate the current geographic location of the electronic device 700 to implement navigation or Location Based Service (LBS). The positioning component 708 may be a positioning component based on the Global Positioning System (GPS) of the United States, the Beidou system of China, the Grenas system of Russia, or the Galileo system of the European Union.

Power supply 709 is used to power various components in electronic device 700. The power supply 709 may be alternating current, direct current, disposable batteries or rechargeable batteries. When the power supply 709 includes a rechargeable battery, the rechargeable battery can support wired charging or wireless charging. The rechargeable battery can also be used to support fast charging technology.

In some implementations, the electronic device 700 also includes one or more sensors 710. The one or more sensors 710 include, but are not limited to, an acceleration sensor 711, a gyroscope sensor 712, a pressure sensor 713, a fingerprint sensor 714, an optical sensor 715 and a proximity sensor 716.

The acceleration sensor 711 can detect the magnitude of acceleration on the three coordinate axes of the coordinate system established by the terminal 700. For example, the acceleration sensor 711 can be used to detect the components of the gravitational acceleration on the three coordinate axes. The processor 701 can control the touch display screen 705 to display the user interface in a landscape view or a portrait view according to the gravitational acceleration signal collected by the acceleration sensor 711. The acceleration sensor 711 can also be used for collecting the movement data of game or user.

The gyroscope sensor 712 can detect the body direction and rotation angle of the terminal 700, and the gyroscope sensor 712 can cooperate with the acceleration sensor 711 to collect 3D actions of the user on the terminal 700. The processor 701 can implement the following functions according to the data collected by the gyro sensor 712: motion sensing (such as changing the UI according to the user's tilt operation), image stabilization during shooting, game control, and inertial navigation.

The pressure sensor 713 may be disposed on the side frame of the terminal 700 and/or the lower layer of the touch display screen 705. When the pressure sensor 713 is disposed on the side frame of the terminal 700, the user's holding signal of the terminal 700 can be detected, and the processor 701 can perform left and right hand identification or shortcut operations according to the holding signal collected by the pressure sensor 713. When the pressure sensor 713 is disposed on the lower layer of the touch display screen 705, the processor 701 controls the operability controls on the UI according to the user's pressure operation on the touch display screen 705. The operability controls include at least one of button controls, scroll bar controls, icon controls, and menu controls.

The fingerprint sensor 714 is used to collect the user's fingerprint, and the processor 701 identifies the user's identity according to the fingerprint collected by the fingerprint sensor 714, or the fingerprint sensor 714 identifies the user's identity according to the collected fingerprint. When the user's identity is identified as a trusted identity, the processor 701 authorizes the user to perform user-related sensitive operations, including unlocking the screen, viewing encrypted information, downloading software, making payments, and changing settings. The fingerprint sensor 714 may be provided on the front, back, or side of the electronic device 700. When the electronic device 700 is provided with physical buttons or a manufacturer's logo, the fingerprint sensor 714 may be integrated with the physical buttons or the manufacturer's logo.

Optical sensor 715 is used to collect ambient light intensity. In one implementation, the processor 701 may control the display brightness of the touch display screen 705 according to the ambient light intensity collected by the optical sensor 715. Specifically, when the ambient light intensity is high, the display brightness of the touch display screen 705 is increased; when the ambient light intensity is low, the display brightness of the touch display screen 705 is decreased. In another implementation, the processor 701 may also dynamically adjust the shooting parameters of the camera assembly 706 according to the ambient light intensity collected by the optical sensor 715.

Proximity sensor 716, also referred to as a distance sensor, is typically provided on the front panel of electronic device 700. Proximity sensor 716 is used to collect the distance between the user and the front of electronic device 700. In one implementation, when the proximity sensor 716 detects that the distance between the user and the front of the terminal 700 gradually decreases, the processor 701 controls the touch display screen 705 to switch from the bright-screen state to the off-screen state; when the proximity sensor 716 detects that the distance between the user and the front of the electronic device 700 gradually increases, the processor 701 controls the touch display screen 705 to switch from the off-screen state to the bright-screen state.

Those skilled in the art can understand that the structure shown in FIG. 7 does not constitute a limitation on the electronic device 700, and may include more or less components than the one shown, or combine some components, or adopt different component arrangements.

According to an implementation of the present disclosure, there may also be provided a computer-readable storage medium storing instructions, wherein the instructions, when executed by at least one processor, cause the at least one processor to perform the method for chorus mixing according to the present disclosure. Examples of the computer-readable storage medium herein include: Read Only Memory (ROM), Random Access Programmable Read Only Memory (PROM), Electrically Erasable Programmable Read Only Memory (EEPROM), Random Access Memory (RAM) , dynamic random access memory (DRAM), static random access memory (SRAM), flash memory, non-volatile memory, CD-ROM, CD-R, CD+R, CD-RW, CD+RW, DVD-ROM , DVD-R, DVD+R, DVD-RW, DVD+RW, DVD-RAM, BD-ROM, BD-R, BD-R LTH, BD-RE, Blu-ray or Optical Disc Storage, Hard Disk Drive (HDD), Solid State Hard disk (SSD), card memory (such as a multimedia card, Secure Digital (SD) card, or Extreme Digital (XD) card), magnetic tape, floppy disk, magneto-optical data storage device, optical data storage device, hard disk, solid state disk, and any other apparatus configured to store the computer program and any associated data, data files and data structures in a non-transitory manner, and provide a processor or computer with the computer program and any associated data, data files and data structures so that the processor or computer can execute the computer program. The computer program in the above-mentioned computer readable storage medium can be executed in an environment deployed in a computer device such as a client, a host, a proxy device, a server, etc. Furthermore, in one example, the computer program and any associated data, data files and data structures are distributed over networked computer systems so that the computer programs and any associated data, data files and data structures are stored, accessed and executed in a distributed fashion by one or more processors or computers.

According to an implementation of the present disclosure, a computer program product can also be provided, wherein instructions in the computer program product can be executed by a processor of a computer device to complete the method for chorus mixing.

The method, apparatus, electronic device, and computer-readable storage medium for chorus mixing according to the implementations of the present disclosure can automatically solve the problem of multiple misplaced audio of the main vocal in chorus and the problem of misplaced chorus audio and main vocal audio, without manual intervention. Furthermore the implementation is simple and reliable, and can guarantee the quality of the choral works.

Other implementations of the present disclosure will readily occur to those skilled in the art upon consideration of the specification and practice of the implementation disclosed herein. This application is intended to cover any variations, uses, or adaptations of the present disclosure that follow the general principles of the present disclosure and include common knowledge or techniques in the technical field not disclosed by the present disclosure. The specification and examples are to be regarded as exemplary only, with the true scope and spirit of the disclosure being indicated by the following claims.

It should be understood that the present disclosure is not limited to what has been described above and shown in the drawings, and various modifications and changes may be made without departing from the scope thereof. The scope of the present disclosure is limited only by the appended claims.

What is claimed is:

1. A method for chorus mixing, comprising:
converting a main vocal audio signal and a chorus audio signal into signals in frequency domain, respectively, wherein the chorus audio signal comprises main vocal audio played by a speaker;
determining a delay between the main vocal audio signal and the chorus audio signal based on a frequency-domain signal of the main vocal audio signal and a frequency-domain signal of the main vocal audio played by the speaker included in a frequency-domain signal of the chorus audio signal;
aligning the chorus audio signal with the main vocal audio signal based on the determined delay;
performing an echo cancellation on the aligned chorus audio signal; and
mixing audio of the main vocal audio signal and the echo-canceled chorus audio signal.

2. The method according to claim 1, wherein said determining the delay comprises:
determining a number of relative offset frames between the frequency-domain signal of the main vocal audio played by the speaker included in the frequency-domain signal of the chorus audio signal and the frequency-domain signal of the main vocal audio signal; and
determining the delay based on the number of relative offset frames.

3. The method according to claim 1, wherein said aligning the chorus audio signal with the main vocal audio signal based on the determined delay comprises:
determining a difference between a first delay and a second delay, wherein the first delay is a delay between the main vocal audio signal and the chorus audio signal at a current moment, and the second delay is a delay between the main vocal audio signal and the chorus audio signal at a previous moment;
in response to the difference being within a predetermined range, adjusting a time of playing the chorus audio signal based on the second delay; and
in response to the difference being out of the predetermined range, adjusting the time of playing the chorus audio signal based on the first delay.

4. The method according to claim 3, wherein said aligning the chorus audio signal with the main vocal audio signal based on the determined delay further comprises:
performing a smoothing processing on an overlap and a break of the adjusted chorus audio signal.

5. The method according to claim 1, wherein said performing the echo cancellation on the aligned chorus audio signal comprises:
performing the echo cancellation on the aligned chorus audio signal with the main vocal audio signal as a reference signal, so as to attenuate a residual main vocal audio signal in the chorus audio signal.

6. The method according to claim 1, wherein said mixing audio of the main vocal audio signal and the echo-cancelled chorus audio signal comprises:
performing an amplitude control on the main vocal audio signal and the echo-canceled chorus audio signal.

7. A method for chorus mixing, comprising:
obtaining a clean main vocal audio signal from a main vocal audio signal with accompaniment;
detecting frequency information of the clean main vocal audio signal and frequency information of a chorus audio signal;
determining a delay between the main vocal audio signal and the chorus audio signal based on time series of the frequency information of the chorus audio signal and time series of frequency information of the clean main vocal audio signal;
aligning the chorus audio signal with the main vocal audio signal based on the determined delay; and
mixing audio of the main vocal audio signal and the aligned chorus audio signal.

8. The method according to claim 7, wherein said determining the delay comprises:
determining the delay between the chorus audio signal and the clean main vocal audio signal based on correlation or a minimum difference value between the time series of the frequency information of the chorus audio signal and the time series of the frequency information of the clean main vocal audio signal.

9. The method according to claim 7, wherein said aligning the chorus audio signal with the main vocal audio signal based on the determined delay comprises:
determining a difference between a third delay and a fourth delay, wherein the third delay is a delay between the clean main vocal audio signal and the chorus audio signal at current moment, and the fourth delay is a delay between the clean main vocal audio signal and the chorus audio signal at a previous moment;
in response to the difference being within a predetermined range, adjusting a time of playing the chorus audio signal based on the fourth delay; and
in response to the difference being out of the predetermined rang, adjusting the time of playing the chorus audio signal based on the third delay.

10. The method according to claim 7, wherein said aligning the chorus audio signal with the main vocal audio signal based on the determined delay further comprises:
performing a smoothing processing on an overlap and a break of the adjusted chorus audio signal.

11. The method according to claim 7, wherein said mixing audio of the main vocal audio signal and the aligned chorus audio signal comprises:
performing an amplitude control on the main vocal audio signal and the aligned chorus audio signal.

12. An electronic device, comprising:
at least one processor;
at least one memory storing instructions executable by the processor,
wherein the processor is configured to:
determine an output mode of a main vocal audio signal;
in response to determining that the output mode of the main vocal audio signal is a speaker mode, perform actions comprising:
converting a main vocal audio signal and a chorus audio signal into signals in frequency domain, respectively, wherein the chorus audio signal comprises main vocal audio played by a speaker;
determining a delay between the main vocal audio signal and the chorus audio signal based on a frequency-domain signal of the main vocal audio signal and a frequency-domain signal of the main vocal audio played by the speaker included in a frequency-domain signal of the chorus audio signal;
aligning the chorus audio signal with the main vocal audio signal based on the determined delay;
performing an echo cancellation on the aligned chorus audio signal; and
mixing audio of the main vocal audio signal and the echo-canceled chorus audio signal.

13. The electronic device according to claim 12, wherein said determining the delay comprises:
determining a number of relative offset frames between the frequency-domain signal of the speaker-on main vocal audio played by the speaker included in the frequency-domain signal of the chorus audio signal and the frequency-domain signal of the main vocal audio signal; and
determining the delay based on the number of relative offset frames.

14. The electronic device according to claim 12, wherein said aligning the chorus audio signal with the main vocal audio signal based on the determined delay comprises:
determining a difference between a first delay and a second delay, wherein the first delay is a delay between the main vocal audio signal and the chorus audio signal at a current moment, and the second delay is a delay between the main vocal audio signal and the chorus audio signal at a previous moment;
in response to the difference being within a predetermined range, adjusting a time of playing the chorus audio signal based on the second delay; and
in response to the difference being out of the predetermined range, adjusting the time of playing the chorus audio signal based on the first delay.

15. The electronic device according to claim 14, wherein said aligning the chorus audio signal with the main vocal audio signal based on the determined delay further comprises:
performing a smoothing processing on an overlap and a break of the adjusted chorus audio signal.

16. The electronic device according to claim 12, wherein said performing the echo cancellation on the aligned chorus audio signal comprises:
performing the echo cancellation on the aligned chorus audio signal with the main vocal audio signal as a reference signal, so as to attenuate a residual main vocal audio signal in the chorus audio signal.

17. The electronic device according to claim 12, wherein said mixing audio of the main vocal audio signal and the echo-cancelled chorus audio signal comprises:
performing an amplitude control on the main vocal audio signal and the echo-canceled chorus audio signal.

18. The electronic device according to claim 12, wherein the processor is further configured to:
in response to determining that the output mode of the main vocal audio signal is a headphone mode, perform actions comprising:
obtaining a clean main vocal audio signal from a main vocal audio signal with accompaniment;
detecting frequency information of the clean main vocal audio signal and frequency information of a chorus audio signal;
determining a delay between the main vocal audio signal and the chorus audio signal based on time series of the frequency information of the chorus audio signal and time series of frequency information of the clean main vocal audio signal;
aligning the chorus audio signal with the main vocal audio signal based on the determined delay; and
mixing audio of the main vocal audio signal and the aligned chorus audio signal.

19. The electronic device according to claim 18, wherein said determining the delay comprises:
determining the delay between the chorus audio signal and the clean main vocal audio signal based on correlation or a minimum difference value between the time series of the frequency information of the chorus audio signal and the time series of the frequency information of the clean main vocal audio signal.

20. The electronic device according to claim 18, wherein said aligning the chorus audio signal with the main vocal audio signal based on the determined delay comprises:
determining a difference between a third delay and a fourth delay, wherein the third delay is a delay between the clean main vocal audio signal and the chorus audio signal at current moment, and the fourth delay is a delay between the clean main vocal audio signal and the chorus audio signal at a previous moment;
in response to the difference being within a predetermined range, adjusting a time of playing the chorus audio signal based on the fourth delay; and
in response to the difference being out of the predetermined rang, adjusting the time of playing the chorus audio signal based on the third delay.
